(19) United States
(12) Patent Application Publication
(10) Pub. No.: US 2012/0271003 A1
(43) Pub. Date: Oct. 25, 2012

(54) Block Copolymers As Thermoplastic Elastomers Made Of Polyisobutene Blocks And Oligoamide Blocks

(76) Inventors: Hannah Maria König, Mannheim (DE); Arno Lange, Bad Durkheim (DE); Holger Frauenrath, Lausanne (CH); Jan Gebers, Lausanne (CH); Emmanuel Croisier, Lausanne (CH); Su Liang, Ecublens (CH); Katalin Feher, Aachen (DE); Roman Niklaus Marty, Lausanne (CH)

(21) Appl. No.: 13/502,184

(22) PCT Filed: Oct. 12, 2010
(86) PCT No.: PCT/EP10/65267

§ 371 Date: Jul. 9, 2012

(30) Foreign Application Priority Data
Oct. 16, 2009 (EP) 09173245.3

(51) Int. Cl. C08L 53/00

(52) U.S. Cl. 525/184

(57) ABSTRACT

Aspects of the invention relate to block copolymers having the properties of thermoplastic elastomers made of blocks on the basis of isobutene monomer units as the soft segment and blocks on the basis of oligoamides composed of at least two base units, each of which comprises an amino or a carbonyl group in the α, β, γ or δ position to each other or directly bound to each other, as the hard segment. Such block copolymers are suited for producing fibers, microfibers, and films.

The present invention relates to novel block copolymers, especially in the form of triblock or multiblock copolymers, with the properties of thermoplastic elastomers, which comprise at least one block (A) based on isobutene monomer units as the soft segment and at least one block (B) based on oligoamides formed from at least two base units each having an amino group and a carbonyl group in the α, β, γ or δ positions relative to one another or bonded directly to one another as the hard segment. The present invention further relates to a process for preparing such block copolymers and to the use thereof for producing fibers, microfibers and films.

Naturally occurring fiber or network materials such as silk, collagen or wood often have astonishing properties, which is all the more remarkable considering that nature generates them under mild physiological conditions. One reason for such features is the fact that such biopolymers typically consist of structures of different three-dimensional scales. In the case of proteins for example, a distinction is drawn between the primary structure which is determined by the amino acid sequence, the secondary structure which forms defined conformations owing to the chain segments preshaped in the primary structure, such as α-helices or β-sheet-type structures, the tertiary structure constituted by defined higher spatial arrangements of the secondary structures, and the quaternary structure which is ultimately the spatial structure of the biologically active protein complexes. It is evident here that the information for self-assembly formation of higher three-dimensional structures is already present at the molecular level.

Such biopolymers are the model for synthetic polymers which should likewise form self-assembly higher three-dimensional structures with performance properties based thereon. For instance, in macromolecules 1995, 28, 4426-4432, B. Zaschke and J. P. Kennedy describe thermoplastic elastomers which consist of bifunctional polyisobutene telechelics as the soft segment and polyamide blocks obtained from dicarboxylic acids and diisocyanates by polyaddition with elimination of CO₂ as the hard segment. The dicarboxylic acids used here by Zaschke and Kennedy were adipic acid, azelaic acid and 1,4-cyclohexanedicarboxylic acid; the diisocyanates they used were p,p′-diphenylmethane diisocyanate, 1,6-diisocyanatohexane, 1,3-bis(isocyanato-methyl)benzene and 1,3-bis(isocyanatomethyl)cyclohexane.

R. H. Wondraczek and J. P. Kennedy describe, in J. Polym. Sci.: Polym. Chem. Ed. 1982, 20, 173-190, diblock, triblock and three-star copolymers formed from nylon-6 blocks and polyisobutene telechelics. The linkage of the hydroxyl-terminated polyisobutene telechelics are linked to the nylon-6 blocks via diisocyanates. The nylon-6 blocks are obtained by polymerizing c-caprolactam. The copolymers described by Wondraczek and Kennedy have advantageous physical properties owing to their higher structures and are, for example, still thermally stable at relatively high temperatures.

H. Frauenrath and coauthors describe, in Angew. Chem. 2006, 118, 5510-5513, and in Nano Letters 2008, Vol. 8, No. 6, 1660-1666, synthetic polymers formed from hydrogenated polyisoprene segments, and oligoamide segments formed from naturally occurring α-amino acids and from optionally amide-terminated diacetylene units. The diacetylene units are finally used to perform a crosslinking polymerization to give the sheet like structure. One oligoamide segment composed of naturally occurring α-amino acids which is mentioned here is tetra-(L-alanine). Owing to their self-assembly higher structures, especially the δ-sheet-type structures thereof, such synthetic polymers are suitable, for example, for optoelectronic applications.

It was an object of the present invention to provide block copolymers with the properties of thermoplastic elastomers with blocks based on isobutene monomer units, especially with polyisobutene telechelics, as soft segments, the hard segments thereof (i) leading through phase segregation from the polyisobutene soft segments to better formation of micro- or nanostructures and/or (ii) having a relatively high degree of chain stiffness and/or monodispersity (molecular homogeneity), as a result forming stable hard domains even at relatively short segment lengths, the characteristic size of which is therefore limited to a few nanometers, and/or (iii) as a result of significant anisotropic aggregation (for example as a result of hydrogen bonds in one spatial direction and as a result of hydrophobic interactions in the other spatial directions) in combination with chirality, being capable of better formation of helical, fibrillar hard domains with a high aspect ratio (ratio of length to diameter), and homogeneous diameter in the nanometer range.

Ultimately, molecular fiber-reinforced composite materials based on such thermoplastic elastomeric block copolymers are also to be provided, the material properties of which, depending on parameters such as the segment lengths, the molecular homogeneity of the hard segments and the chirality, are improved.

Accordingly, block copolymers with the properties of thermoplastic elastomers have been found, which comprise at least one block (A) based on isobutene monomer units as the soft segment and at least one block (B) based on oligoamides formed from at least two base units each having an amino group and a carbonyl group in the α, β, γ or δ positions relative to one another or bonded directly to one another as the hard segment.

Properties of thermoplastic elastomers shall be understood here to mean especially the plastic deformability of the block copolymers with hard and soft segments with supply of heat, which causes thermoplastic behavior. Thermoplastic elastomers have, in regions of their molecules, physical crosslinking points (secondary valence forces or crystallites) which dissolve under hot conditions without the macromolecules decomposing; they can therefore be processed better than “normal” elastomers. Typical measurable physical material properties of thermoplastic elastomers are the compression set (to DIN 53 517 or DIN ISO 815 or ASTM D 395) or the tension set and the stress relaxation. The compression set or tension set is a measure of how such elastomers behave under long-lasting constant compression and subsequent relaxation: a value of 0% means that the body has completely attained its original thickness or shape again (which in reality is impossible); a value of 100% means that the body was completely deformed during the test and exhibits no resilience. The inventive block copolymers should, in a compression set test, provide a value of significantly below 100%, especially below 80%, in particular below 50%.

In a preferred embodiment, the at least one block (A) is a monofunctional polyisobutene block. Monofunctional polyisobutene is typically prepared from high-reactivity polyisobutene, i.e. a polyisobutene with a high proportion of terminal, highly reactive vinylidene double bonds, for example by hydroformylation and subsequent hydrogenating amination according to EP-B 244 616. Such polyisobutenamines can be coupled readily onto the oligoamides of the blocks (B) via the terminal amino function.

In a further preferred embodiment, the at least one block (A) of the inventive block copolymers is a polyisobutene telechelic. Telechelic polyisobutene is typically prepared from a di- or polyfunctional initiator (also known as “inifer”) and isobutene by specific polymerization techniques. The polyisobutene telechelics thus obtained have two or more polyisobutene chains or (in the case of star-shaped molecules) polyisobutene branches, for example three or four polyisobutene branches, the distal ends of which, after the polymerization reaction has been terminated, generally bear halogen atoms or ethylenic double bonds. For further conversion to the inventive block copolymers, these can be converted to other functional moieties, for example to amine, alcohol, aldehyde, isocyanate or thiol functions, or to halides or to ethylenic or allylic double bonds which can give better coupling options to the blocks (B). The number of functional moieties which serve for coupling to the blocks (B) in the polyisobutene telechelics is 1 to 3, preferably 1 or 2, per polyisobutene chain or polyisobutene branch.

To link the polyisobutene blocks (A) to the blocks (B) comprising the oligoamides, it is also possible to use customary peptide coupling reagents in the manner of functional moieties on the blocks (A). Examples for this purpose are the benzotriazol-1-yloxytrispyrrolidinophosphonium hexafluorophosphate/N,N-diisopropylethylamine (“Hunig's base”) (“PyBOP/DIEA”) and N-(3-dimethylaminopropyl)-N′-ethylcarbodiimide hydrochloride/hydroxybenzotriazole hydrate/N,N-diisopropylethylamine (“EDCl/HOBUDIEA”) systems.

A typical preparation method for such a polyisobutene telechelic is described in DE 10 2005 002 772 Al. Typical initiators here are 1,3-bis(1-bromo-1-methylethyl)benzene, 1,3-bis(2-chloro-2-propyl)benzene (1,3-dicumyl chloride) and 1,4-bis(2-chloro-2-propyl)benzene (1,4-dicumyl chloride).

A further preferred embodiment is that of inventive block copolymers in which the at least one block (A) is a polyisobutene block, especially a polyisobutene telechelic, having a number-average molecular weight of 270 to 5000, preferably of 380 to 5000, in particular of 500 to 5000. The initiator unit is present here in the amounts specified.

The oligoamides of the block (B) of the inventive block copolymers are formed in a formal sense from at least two, especially from 2 to 20, in particular from 2 to 10, for example from 2, 3, 4, 5 or 6, base units which preferably each have an amino group and a carboxyl group in the a, 6, y or 6 positions relative to one another in the same molecule before the oligomerization. The amino group is especially a primary amino group. These base units are thus preferably amino acids. The oligoamide formation (oligomerization) preferably takes place by polycondensation of the amino acid molecules, which may be the same or different, the carboxyl groups of the amino acids used also being usable in the form of reactive derivatives such as carbonyl halides, carboxylic anhydrides or carboxylic esters. The base units used may in principle also be corresponding internal cyclic amides or betaine structures (internal salts). The oligoamide units thus have, in the case of primary amino groups, generally the structure of chains of the formula —CO—X—NH—(CO—X—NH)ₙ— where X denotes the remaining structure of the identical or different amino acids and n represents a number 1, especially 1 to 19.

In a preferred embodiment, the at least one block (B) of the inventive block copolymers comprises oligoamides of aliphatic α-, β-, γ- or δ-amino acids or of aromatic β-, γ- or δ-amino acids. Examples of underlying aliphatic β-amino acid base units are 3-aminopropionic acid (β-alanine), 3-aminobutyric acid or 2-aminocyclohexane-carboxylic acid. Examples of underlying aliphatic γ-amino acid base units are 4-aminobutyric acid, 4-aminopentanoic acid or 3-ami nocyclohexanecarboxylic acid. Examples of underlying aliphatic δ-amino acid base units are 5-aminopentanoic acid, 5-aminohexanoic acid or 4-aminocyclohexanecarboxylic acid. One example of an underlying aromatic β-amino acid base unit is ortho-aminobenzoic acid (anthranilic acid). One example of an underlying aromatic y-amino acid base unit is meta-aminobenzoic acid. One example of an underlying aromatic 6-amino acid base unit is para-aminobenzoic acid. Oligoamides of aromatic amino acids are also referred to generally as oligoaramides.

Particular preference is given to inventive block copolymers in which the at least one block (B) comprises oligoamides, especially monodisperse oligoamides, of α-amino acids. Very particular preference is given to inventive block copolymers in which the at least one block (B) comprises oligopeptides, especially monodisperse oligopeptides, of naturally occurring α-amino acids as oligoamides. “Monodisperse” shall be understood here to mean that the oligoamides are specific molecule units of defined length and structure and are not subject to any statistical distribution in this regard, as is otherwise the case for polymer molecules. In other words, the polydispersity of such monodisperse oligoamide units assumes the value of 1.0.

Naturally occurring α-amino acids are typically understood to mean the following: alanine (Ala), arginine (Arg), cysteine (Cys), glycine (Gly), histidine (His), isoleucine (Ile), leucine (Leu), lysine (Lys), methionine (Met), phenylalanine (Phe), proline (Pro), serine (Ser), threonine (Thr), tryptophan (Trp), tyrosine (Tyr), valine (Val), aspartic acid (Asp), asparagine (Asn), glutamic acid (Glu) and glutamine (Gin). Those among these which have only one carboxyl group and only one primary amino group in the molecule, i.e. Ala, Cys, Gly, His, Ile, Leu, Met, Phe, Ser, Thr, Trp, Tyr and Val, afford linear oligopeptides. Crosslinked or branched oligopeptides comprise those of the above-mentioned α-amino acids which have a plurality of carboxyl groups or a plurality of amino groups in the molecule.

Further suitable α-amino acids are, for example, cystathionine, cystine, homo-cysteine, homoserine, lanthionine, norleucine, norvaline, ornithine, sarcosine, thyronine, hippuric acid, allophanic acid and hydantoic acid.

The α-amino acids used may be used either in the (naturally occurring) L configuration or in the D configuration.

Synthesis methods performable in practice for such oligoamides or oligopeptides are known to those skilled in the art. In addition to the reaction, developed by Emil Fischer, of α-halocarbonyl chlorides with amino acid esters unprotected on the amino group and subsequent exchange of the halogen for an amino group with ammonia, methods which have become established are especially those which use amino acids with a protected amino group. It is crucial here that the protecting group in question is readily redetachable after the amide or peptide formation without the amide or peptide bond being broken at the same time.

A further synthesis method for the so-called oligoamides or oligopeptides is the ring-opening oligomerization of amino acid N-carboxyanhydrides (“NCA”), as described, for example, in EP-A 2 067 801, with the corresponding homooligomers, random cooligomers and graft cooligomers. NCAs are five-membered cyclic carboxylic anhydrides with one ring nitrogen atom, which can be prepared from 2-substituted amino acids, especially from 2-substituted α-amino acids, or from the dimers or trimers of such amino acids with phosgene or triphosgene. The ring-opening oligomerization is initiated especially by primary, secondary or tertiary amines, and also by alcohols, water or acids. Functionalities which could disrupt the oligomerization can be blocked by protecting groups. Examples of NCAs of interest in the context of the present invention are those which are formed from glycine, alanine, valine, norvaline, leucine, isoleucine, norleucine, phenylalanine, tert-butylserine, tert-butyltyrosine, tert-butylaspartic acid and N-phenylglycine (gives the “Leuchs anhydride”), the tert-butyl functions constituting protecting groups for hydroxyl groups.

Typical peptide sequences for suitable oligopeptides are as follows:

(Ala)₁₊ₙ
where n = 1, 2, 3, 4 or 5
(Gly)₁₊ₙ
where n = 1, 2, 3, 4 or 5
(Cys)₁₊ₙ
where n = 1, 2, 3, 4 or 5
(Ala)₁₊ₙ-Cys
where n = 0, 1, 2, 3 or 4
(Gly)₁₊ₙ-Cys
where n = 0, 1, 2, 3 or 4
Val-(Thr)₁₊ₙ
where n = 0, 1, 2, 3 or 4
Val-(Thr)₁₊ₙ-Gly
where n = 0, 1, 2 or 3
Ala-(Gly)₁₊ₙ-Ala
where n = 0, 1, 2 or 3
Gly-(Ala)₁₊ₙ-Gly
where n = 0, 1, 2 or 3
Ala-Gly-Ala-Gly-Ala
Val-Thr-Val-Thr-Gly
Val-Pro-Gly-Val-Gly
Ala-Gly-Arg-Gly-Asp
Gly-Arg-Gly-Asp-Ser
Ile-Lys-Val-Ala-Val
Lys-Thr-Thr-Lys-Ser
Gly-Glu-Ala-Lys-Ala
Gly-Arg-Ala-Glu-Ala
Tyr-Gly-Phe-Gly-Gly

The oligoamide units or oligoamide chains consist preferably of 2 to 10, especially of 2, 3, 4, 5 or 6, of the identical or different amino acid units mentioned.

In a further preferred embodiment, the at least one block (B) of the inventive block copolymers comprises additional structural elements (S) selected from protecting groups, chromophores, fluorophores, organic semiconductors and precursors for such structural elements, each of which are at the distal end of the oligoamide unit or oligoamide chain or join a block (B) to a block (A) or two blocks (B) to one another. The structural elements (S) may be monovalent or polyvalent, for example divalent. Thus, block copolymer arrangements, especially of the (A)-(B)-(S), (B)-(S)-(A), (S)-(B)-(A)-(B)-(S) and [(A)-(B)-(S)-(B)-(A)]ₚ (p≧1) type, are comprised.

Protecting groups serve principally to control the synthesis of the oligoamides or oligopeptides mentioned. For this purpose, all moieties typically used in peptide chemistry, as protecting groups in general, are suitable. Usually, the amino group of the amino acid is capped with such a protecting group and then reacted with the further amino acid to form a peptide bond (CO—NH). It is crucial that this protecting group, if it is not to remain permanently but temporarily in the molecule, is readily redetachable after the peptide formation without the peptide bond being broken again at the same time. Typical protecting groups for amino functions are benzyloxycarbonyl, tert-butyloxycarbonyl (“Boc”), para-tosyl, phthalyl, formyl, acetyl (“Ac”), trifluoroacetyl, 9-fluorenylmethoxycarbonyl (“Fmoc”) or dimethylglycine (“GlyMe2”).

Chromophores, fluorophorenes and organic semiconductors as additional structural elements (S) are moieties which have readily mobile electron systems and can therefore cause color effects, optoelectronic effects and/or electrical effects in or with the inventive block copolymers. Such moieties may be mono- or polyfunctional, for example bifunctional. Bifunctional moieties also serve as bridging reagents for linkage of blocks in the inventive block copolymer. The structural elements (S) may in principle be formed from a functional part, which, for example, performs the protecting group function or accommodates the readily mobile electron system, and a spacer from or linking element to the rest of the molecule. Typical moieties (S) are obtained, for example, by modification of the blocks (B) with oligo-(2,5-thienylenes) (“oligothiophenes”) of the formula —(C₄H₂S)ᵣ— where q=1 to 6 repeat units, oligo-1,4-phenylenes (“oligophenylenes”) of the formula —(C₆H₄)ᵣ— where r=1 to 6 repeat units or with “rylene derivatives” such as naphthalenedicarboxylic anhydride, naphthalenetetracarboxylic dianhydride, perylene-3,4-dicarboxylic 3,4-anhydride, perylene-3,4,9,10-tetracarboxylic 3,4,9,10-dianhydride, terylenedicarboxylic anhydride, terylenetetracarboxylic dianhydride, quaterylenedicarboxylic anhydride, quaterylenetetracarboxylic dianhydride, corresponding higher rylenedicarboxylic anhydrides and corresponding higher rylenetetracarboxylic dianhydrides, coronenedicarboxylic anhydride, coronenetetracarboxylic dianhydride, hexaperihexabenzocoronenedicarboxylic anhydride, hexaperihexabenzocoronenetetracarboxylic dianhydride, and fullerene derivatives such as fulleropyrrolidine.

An alternative embodiment which also forms part of the subject matter of the present invention is that of block copolymers in which the at least one block (B) comprises at least one additional structural element (S′) selected from chromophores, fluorophores, organic semiconductors and precursors for such structural elements, which is arranged between two amide moieties. The chromophores, fluorophores, organic semiconductors and precursors for such structural elements (S′) are the same as specified above for the structural elements (S). The two amide moieties on each side may each be constituents of oligoamide sub-blocks formed, for example, from two, especially from 2 to 10, in particular from 2 to 5, for example from 2 or 3, amide base units, or be present as the sole amide group in each case at each end of such a block (B). Between these amide moieties on each side and the structural element (S′), spacers may be incorporated.

Typical examples of blocks (B) with such a central structural element (S′) are α,ω-biscarboxamides of the formula —NH—CO-alkylene-S′-alkylene-CO—NH—, where “alkylene” denotes spacers in the form of C₁- to C₁₂-alkylene moieties, especially C₁- to C₆-alkylene moieties such as methylene, 1,2-ethylene, 1,3-propylene, 1,4-butylene, 1,6-hexylene or 1,4-cyclohexylene.

The present invention also provides diblock copolymers of the (A)-(B)-R structure in which (A) denotes monofunctional polyisobutene blocks and (B) denotes blocks according to the above description, and R is hydrogen or structural elements (S), especially protecting groups. Such diblock copolymers are the simplest technical means of implementing the inventive block copolymers with monofunctional polyisobutene blocks (A).

Typical examples of inventive diblock copolymers are structures of the PIB-(AA)₁₊ₙ—R type where AA represents amino acids, especially α-amino acids, in particular naturally occurring α-amino acids, PIB here denotes a monofunctional polyisobutene, R is hydrogen or additional structural elements (S) and n is an integer from 1 to 9, especially from 1 to 5. AA represents identical or different amino acids of this type. The linkage between PIB and AA is through suitable functional groups or linking reagents.

Illustrative individual structures for the inventive diblock copolymers are as follows:

PIB-(Ala)₁₊ₙ-H
where n = 1, 2, 3, 4 or 5
PIB-(Gly)₁₊ₙ-H
where n = 1, 2, 3, 4 or 5
PIB-(Cys)₁₊ₙ-H
where n = 1, 2, 3, 4 or 5
PIB-(Ala)₁₊ₙ-Ac
where n = 1, 2, 3, 4 or 5
PIB-(Gly)₁₊ₙ-Ac
where n = 1, 2, 3, 4 or 5
PIB-(Cys)₁₊ₙ-Ac
where n = 1, 2, 3, 4 or 5
PIB-(Ala)₁₊ₙ-Fmoc
where n = 1, 2, 3, 4 or 5
PIB-(Gly)₁₊ₙ-Fmoc
where n = 1, 2, 3, 4 or 5
PIB-(Cys)₁₊ₙ-Fmoc
where n = 1, 2, 3, 4 or 5
PIB-(Ala)₁₊ₙ-Cys-H
where n = 0, 1, 2, 3 or 4
PIB-(Ala)₁₊ₙ-Cys-Ac
where n = 0, 1, 2, 3 or 4
PIB-(Ala)₁₊ₙ-Cys-Fmoc
where n = 0, 1, 2, 3 or 4
PIB-Cys-(Ala)₁₊ₙ-H
where n = 0, 1, 2, 3 or 4
PIB-Cys-(Ala)₁₊ₙ-Ac
where n = 0, 1, 2, 3 or 4
PIB-Cys-(Ala)₁₊ₙ-Fmoc
where n = 0, 1, 2, 3 or 4
PIB-Cys-(Gly)₁₊ₙ-H
where n = 0, 1, 2, 3 or 4
PIB-Cys-(Gly)₁₊ₙ-Ac
where n = 0, 1, 2, 3 or 4
PIB-Cys-(Gly)₁₊ₙ-Fmoc
where n = 0, 1, 2, 3 or 4
P1B-(Gly)₁₊ₙ-Cys-H
where n = 0, 1, 2, 3 or 4
P1B-(Gly)₁₊ₙ-Cys-Ac
where n = 0, 1, 2, 3 or 4
PIB-(Gly)₁₊ₙ-Cys-Fmoc
where n = 0, 1, 2, 3 or 4
PIB-Val-(Thr)₁₊ₙ-H
where n = 0, 1, 2, 3 or 4
PIB-Val-(Thr)₁₊ₙ-Ac
where n = 0, 1, 2, 3 or 4
PIB-Val-(Thr)₁₊ₙ-Fmoc
where n = 0, 1, 2, 3 or 4
PIB-(Thr)₁₊ₙ-Val-H
where n = 0, 1, 2, 3 or 4
PIB-(Thr)₁₊ₙ-Val-Ac
where n = 0, 1, 2, 3 or 4
PIB-(Thr)₁₊ₙ-Val-Fmoc
where n = 0, 1, 2, 3 or 4
PIB-Ala-(Gly)₁₊ₙ-Ala-H
where n = 0, 1, 2 or 3
PIB-Ala-(Gly)₁₊ₙ-Ala-Ac
where n = 0, 1, 2 or 3
PIB-Ala-(Gly)₁₊ₙ-Ala-Fmoc
where n = 0, 1, 2 or 3
PIB-Gly-(Ala)₁₊ₙ-Gly-H
where n = 0, 1, 2 or 3
PIB-Gly-(Ala)₁₊ₙ-Gly-Ac
where n = 0, 1, 2 or 3
PIB-Gly-(Ala)₁₊ₙ-Gly-Fmoc
where n = 0, 1, 2 or 3
PIB-Gly-(Thr)₁₊ₙ-Val-H
where n = 0, 1, 2 or 3
PIB-Gly-(Thr)₁₊ₙ-Val-Ac
where n = 0, 1, 2 or 3
PIB-Gly-(Thr)₁₊ₙ-Val-Fmoc
where n = 0, 1, 2 or 3
PIB-Val-(Thr)₁₊ₙ-Gly-H
where n = 0, 1, 2 or 3
PIB-Val-(Thr)₁₊ₙ-Gly-Ac
where n = 0, 1, 2 or 3
PIB-Val-(Thr)₁₊ₙ-Gly-Fmoc
where n = 0, 1, 2 or 3
PIB-Ala-Gly-Ala-Gly-Ala-H
PIB-Gly-Thr-Val-Thr-Val-H
PIB-Gly-Val-Gly-Pro-Val-H
PIB-Asp-Gly-Arg-Gly-Ala-H
PIB-Ser-Asp-Gly-Arg-Gly-H
PIB-Val-Ala-Val-Lys-Ile-H
PIB-Ala-Gly-Ala-Gly-Ala-Ac
PIB-Gly-Thr-Val-Thr-Val-Ac
PIB-Gly-Val-Gly-Pro-Val-Ac
PIB-Asp-Gly-Arg-Gly-Ala-Ac
PIB-Ser-Asp-Gly-Arg-Gly-Ac
PIB-Val-Ala-Val-Lys-Ile-Ac
PIB-Ala-Gly-Ala-Gly-Ala-Fmoc
PIB-Gly-Thr-Val-Thr-Val-Fmoc
PIB-Gly-Val-Gly-Pro-Val-Fmoc
PIB-Asp-Gly-Arg-Gly-Ala-Fmoc
PIB-Ser-Asp-Gly-Arg-Gly-Fmoc
PIB-Val-Ala-Val-Lys-11e-Fmoc
PIB-Lys-Thr-Thr-Lys-Ser-H
PIB-Gly-Glu-Ala-Lys-Ala-H
PIB-Gly-Arg-Ala-Glu-Ala-H
PIB-Tyr-Gly-Phe-Gly-Gly-H
PIB-Lys-Thr-Thr-Lys-Ser-Ac
PIB-Gly-Glu-Ala-Lys-Ala-Ac
PIB-Gly-Arg-Ala-Glu-Ala-Ac
PIB-Tyr-Gly-Phe-Gly-Gly-Ac
PIB-Lys-Thr-Thr-Lys-Ser-Fmoc
PIB-Gly-Glu-Ala-Lys-Ala-Fmoc
PIB-Gly-Arg-Ala-Glu-Ala-Fmoc
PIB-Tyr-Gly-Phe-Gly-Gly-Fmoc

The present invention further provides triblock copolymers of the R-(B)-(A)-(B)-R structure in which (A) denotes polyisobutene telechelics and (B) denotes blocks according to the above description, and R is hydrogen or the abovementioned structural elements (S), especially protecting groups. The two blocks (B) are different or preferably the same. Such triblock copolymers are the simplest technical means of implementing the inventive block copolymers with telechelic polyisobutene blocks (A).

Typical examples of inventive triblock copolymers are structures of the R-(AA)₁₊ₙ-PIB-(AA)₁₊ₙ-R type where AA represents amino acids, especial α-amino acids, in particular naturally occurring α-amino acids, PIB here denotes a bifunctional polyisobutene telechelic, R is hydrogen or additional structural elements (S) and n is an integer from 1 to 9, especially from 1 to 5. AA represents identical or different amino acids of this type. The two variables R may likewise have identical or different definitions. The linkage between PIB and AA is through suitable functional groups or linking reagents.

Illustrative individual structures for the inventive triblock copolymers are as follows:

H-(Gly)₁₊ₙ-PIB-(Gly)₁₊ₙ-H
where n = 1, 2, 3, 4 or 5
H-(Cys)₁₊ₙ-PIB-(Cys)₁₊ₙ-H
where n = 1, 2, 3, 4 or 5
Ac-(Ala)₁₊ₙ-PIB-(Ala)₁₊ₙ-Ac
where n = 1, 2, 3, 4 or 5
Ac-(Gly)₁₊ₙ-PIB-(Gly)₁₊ₙ-Ac
where n = 1, 2, 3, 4 or 5
Ac-(Cys)₁₊ₙ-PIB-(Cys)₁₊ₙ-Ac
where n = 1, 2, 3, 4 or 5
Fmoc-(Ala)₁₊ₙ-PIB-(Ala)₁₊ₙ-Fmoc
where n = 1, 2, 3, 4 or 5
Fmoc-(Gly)₁₊ₙ-PIB-(Gly)₁₊ₙ-Fmoc
where n = 1, 2, 3, 4 or 5
Fmoc-(Cys)₁₊ₙ-PIB-(Cys)₁₊ₙ-Fmoc
where n = 1, 2, 3, 4 or 5
H-Cys-(Ala)₁₊ₙ-PIB-(Ala)₁₊ₙ-Cys-H
where n = 0, 1, 2, 3 or 4
Ac-Cys-(Ala)₁₊ₙ-PIB-(Ala)₁₊ₙ-Cys-Ac
where n = 0, 1, 2, 3 or 4
Fmoc-Cys-(Ala)₁₊ₙ-PIB-(Ala)₁₊ₙ-Cys-Fmoc
where n = 0, 1, 2, 3 or 4
H-(Ala)₁₊ₙ-Cys-PIB-Cys-(Ala)₁₊ₙ-H
where n = 0, 1, 2, 3 or 4
Ac-(Ala)₁₊ₙ-Cys-PIB-Cys-(Ala)₁₊ₙ-Ac
where n = 0, 1, 2, 3 or 4
Fmoc-(Ala)₁₊ₙ-Cys-PIB-Cys-(Ala)₁₊ₙ-Fmoc
where n = 0, 1, 2, 3 or 4
H-(Gly)₁₊ₙ-Cys-PIB-Cys-(Gly)₁₊ₙ-H
where n = 0, 1, 2, 3 or 4
Ac-(Gly)₁₊ₙ-Cys-PIB-Cys-(Gly)₁₊ₙ-Ac
where n = 0, 1, 2, 3 or 4
Fmoc-(Gly)₁₊ₙ-Cys-PIB-Cys-(Gly)₁₊ₙ-Fmoc
where n = 0, 1, 2, 3 or 4
H-Cys-(Gly)₁₊ₙ-PIB-(Gly)₁₊ₙ-Cys-H
where n = 0, 1, 2, 3 or 4
Ac-Cys-(Gly)₁₊ₙ-PIB-(Gly)₁₊ₙ-Cys-Ac
where n = 0, 1, 2, 3 or 4
Fmoc-Cys-(Gly)₁₊ₙ-PIB-(Gly)₁₊ₙ-Cys-Fmoc
where n = 0, 1, 2, 3 or 4
H-(Thr)₁₊ₙ-Val-PIB-Val-(Thr)₁₊ₙ-H
where n = 0, 1, 2, 3 or 4
Ac-(Thr)₁₊ₙ-Val-PIB-Val-(Thr)₁₊ₙ-Ac
where n = 0, 1, 2, 3 or 4
Fmoc-(Thr)₁₊ₙ-Val-PIB-Val-(Thr)₁₊ₙ-Fmoc
where n = 0, 1, 2, 3 or 4
H-Val-(Thr)₁₊ₙ-PIB-(Thr)₁₊ₙ-Val-H
where n = 0, 1, 2, 3 or 4
Ac-Val-(Thr)₁₊ₙ-PIB-(Thr)₁₊ₙ-Val-Ac
where n = 0, 1, 2, 3 or 4
Fmoc-Val-(Thr)₁₊ₙ-PIB-(Thr)₁₊ₙ-Val-Fmoc
where n = 0, 1, 2, 3 or 4
H-Ala-(Gly)₁₊ₙ-Ala-PIB-Ala-(Gly)₁₊ₙ-Ala-H
where n = 0, 1, 2 or 3
Ac-Ala-(Gly)₁₊ₙ-Ala-PIB-Ala-(Gly)₁₊ₙ-Ala-Ac
where n = 0, 1, 2 or 3
Fmoc-Ala-(Gly)₁₊ₙ-Ala-PIB-Ala-(Gly)₁₊ₙ-Ala-Fmoc
where n = 0, 1, 2 or 3
H-Gly-(Ala)₁₊ₙ-Gly-PIB-Gly-(Ala)₁₊ₙ-Gly-H
where n = 0, 1, 2 or 3
Ac-Gly-(Ala)₁₊ₙ-Gly-PIB-Gly-(Ala)₁₊ₙ-Gly-Ac
where n = 0, 1, 2 or 3
Fmoc-Gly-(Ala)₁₊ₙ-Gly-PIB-Gly-(Ala)₁₊ₙ-Gly-Fmoc
where n = 0, 1, 2 or 3
H-Val-(Thr)₁₊ₙ-Gly-PIB-Gly-(Thr)₁₊ₙ-Val-H
where n = 0, 1, 2 or 3
Ac-Val-(Thr)₁₊ₙ-Gly-PIB-Gly-(Thr)₁₊ₙ-Val-Ac
where n = 0, 1, 2 or 3
Fmoc-Val-(Thr)₁₊ₙ-Gly-PIB-Gly-(Thr)₁₊ₙ-Val-Fmoc
where n = 0, 1, 2 or 3
H-Gly-(Thr)₁₊ₙ-Val-PIB-Val-(Thr)₁₊ₙ-Gly-H
where n = 0, 1, 2 or 3
Ac-Gly-(Thr)₁₊ₙ-Val-PIB-Val-(Thr)₁₊ₙ-Gly-Ac
where n = 0, 1, 2 or 3
Fmoc-Gly-(Thr)₁₊ₙ-Val-PIB-Val-(Thr)₁₊ₙ-Gly-Fmoc
where n = 0, 1, 2 or 3
H-Ala-Gly-Ala-Gly-Ala-PIB-Ala-Gly-Ala-Gly-Ala-H
H-Val-Thr-Val-Thr-Gly-PIB-Gly-Thr-Val-Thr-Val-H
H-Val-Pro-Gly-Val-Gly-PIB-Gly-Val-Gly-Pro-Val-H
H-Ala-Gly-Arg-Gly-Asp-PIB-Asp-Gly-Arg-Gly-Ala-H
H-Gly-Arg-Gly-Asp-Ser-PIB-Ser-Asp-Gly-Arg-Gly-H
H-Ile-Lys-Val-Ala-Val-PIB-Val-Ala-Val-Lys-Ile-H
Ac-Ala-Gly-Ala-Gly-Ala-PIB-Ala-Gly-Ala-Gly-Ala-Ac
Ac-Val-Thr-Val-Thr-Gly-PIB-Gly-Thr-Val-Thr-Val-Ac
Ac-Val-Pro-Gly-Val-Gly-PIB-Gly-Val-Gly-Pro-Val-Ac
Ac-Ala-Gly-Arg-Gly-Asp-PIB-Asp-Gly-Arg-Gly-Ala-Ac
Ac-Gly-Arg-Gly-Asp-Ser-PIB-Ser-Asp-Gly-Arg-Gly-Ac
Ac-Ile-Lys-Val-Ala-Val-PIB-Val-Ala-Val-Lys-Ile-Ac
Fmoc-Ala-Gly-Ala-Gly-Ala-PIB-Ala-Gly-Ala-Gly-Ala-
Fmoc
Fmoc-Val-Thr-Val-Thr-Gly-PIB-Gly-Thr-Val-Thr-Val-
Fmoc
Fmoc-Val-Pro-Gly-Val-Gly-PIB-Gly-Val-Gly-Pro-Val-
Fmoc
Fmoc-Ala-Gly-Arg-Gly-Asp-PIB-Asp-Gly-Arg-Gly-Ala-
Fmoc
Fmoc-Gly-Arg-Gly-Asp-Ser-PIB-Ser-Asp-Gly-Arg-Gly-
Fmoc
Fmoc-Ile-Lys-Val-Ala-Val-PIB-Val-Ala-Val-Lys-Ile-
Fmoc
H-Ser-Lys-Thr-Thr-Lys-PIB-Lys-Thr-Thr-Lys-Ser-H
H-Ala-Lys-Ala-Glu-Gly-PIB-Gly-Glu-Ala-Lys-Ala-H
H-Ala-Glu-Ala-Arg-Gly-PIB-Gly-Arg-Ala-Glu-Ala-H
H-Gly-Gly-Phe-Gly-Thr-PIB-Tyr-Gly-Phe-Gly-Gly-H
Ac-Ser-Lys-Thr-Thr-Lys-PIB-Lys-Thr-Thr-Lys-Ser-Ac
Ac-Ala-Lys-Ala-Glu-Gly-PIB-Gly-Glu-Ala-Lys-Ala-Ac
Ac-Ala-Glu-Ala-Arg-Gly-PIB-Gly-Arg-Ala-Glu-Ala-Ac
Ac-Gly-Gly-Phe-Gly-Thr-PIB-Tyr-Gly-Phe-Gly-Gly-Ac
Fmoc-Ser-Lys-Thr-Thr-Lys-PIB-Lys-Thr-Thr-Lys-Ser-
Fmoc
Fmoc-Ala-Lys-Ala-Glu-Gly-PIB-Gly-Glu-Ala-Lys-Ala-
Fmoc
Fmoc-Ala-Glu-Ala-Arg-Gly-PIB-Gly-Arg-Ala-Glu-Ala-
Fmoc
Fmoc-Gly-Gly-Phe-Gly-Thr-PIB-Tyr-Gly-Phe-Gly-Gly-
Fmoc

The inventive triblock copolymers mentioned can generally be processed readily by electro spinning (typically in a 25 to 30% by weight chloroform solution, for example at 15 000 V and distance 14 cm) to give microfibers, and by melt spinning or solution spinning to give fibers, and form stable elastomeric films.

The triblock copolymers Ac-Cys-(AA)₁₊ₙ-PIB-(AS)₁₊ₙ-Cys-Ac, especially Ac-Cys-(Ala)₁₊ₙ-PIB-(Ala)₁₊ₙ-Cys-Ac, can be used in a similar manner to produce fibers, microfibers or film, which can be converted by subsequent air oxidation of the thiol functions from the cysteine to insoluble polymers of much higher molecular weight with the repeat unit

—CH₂—CH(NHAc)-CO-(AA)₁₊ₙ-PIB-(AA)₁₊ₙ-CO—CH(NHAc)-CH₂—S—S— (n=1 to 5) or

—CH₂—CH(NHAc)-CO-(Ala)₁₊ₙ-PIB-(Ala)₁₊ₙ-CO—CH(NHAc)-CH₂—S—S— (n=1 to 5).

The present invention also provides multiblock copolymers which comprise, as macrostructural elements, triblock copolymer structural elements of the formula -(B)-(A)-(B)- in which (A) and (B) denote blocks according to the above description. The linkage between the blocks (A) and (B) is through suitable functional groups or linking reagents.

Typically, such inventive multiblock copolymers can be obtained by reacting the triblock copolymers described with dicarbonyl halides of the general formula Hal-CO-Y-CO-Hal in which Hal denotes halogen such as iodine, fluorine, bromine or especially chlorine and Y is a bridging member which is selected from C₁- to C₁₂-alkylene, C₅- to C₇-cycloalkylene and phenylene, or with dicarboxylic anhydrides, especially those with cyclic structure of the general formula (—CO—Y—CO—)O in which Y is as defined above, or with diisocyanates of the general formula OCN—Y—NCO in which Y is as defined above, as linking reagents. Examples of the dicarbonyl halides mentioned are malonyl chloride, succinyl chloride, glutaryl chloride, adipoyl chloride, hexanedicarbonyl chloride, octanedicarbonyl chloride, decanedicarbonyl chloride, 1,2-cyclohexanedicarbonyl chloride, 1,3-cyclohexanedicarbonyl chloride, 1,4-cyclohexanedicarbonyl chloride, phthaloyl chloride, isophthaloyl chloride and terephthaloyl chloride. Examples of the dicarboxylic anhydrides mentioned are maleic anhydride, succinic anhydride and glutaric anhydride. Examples of the diisocyanates mentioned are hexylene 1,6-diisocyanate, phenylene 1,4-diisocyanate, tolylene 2,4-diisocyanate, tolylene 2,6-diisocyanate, diphenyl 4,4′-diisocyanate, diphenylmethane 4,4′-diisocyanate and naphthalene 1,5-diisocyanate. It is also possible for the abovementioned structural elements (S) to serve as such linking reagents when they have dihalide, dicarboxylic anhydride or diisocyanate functionalities.

This gives multiblock copolymer structures with the repeat unit

—CO—Y—CO-(AA)₁₊ₙ-PIB-(AA)₁₊ₙ- or

—CO—NH—Y—NH—CO-(AA)₁₊ₙ-PIB-(AA)₁₊ₙ₋

in which the variables Y, AA, PIB and n are each as defined above. The amino acids (AA), according to the functional groups or linking reagents used for the linking, may be aligned with the amino function to give the (for example carboxy-functionalized) PIB block or preferably with the carboxyl function to give the (for example amino-functionalized) PIB block.

Other inventive multiblock copolymers are the relatively high molecular weight polymers already mentioned above with the repeat unit

—CH₂—CH(NHAc)-CO-(AA)₁₊ₙ-PIB-(AA)₁₊ₙ-CO—CH(NHAc)-CH₂—S—S— (n=1 to 5) or

—CH₂—CH(NHAc)-CO-(Ala)₁₊ₙ-PIB-(Ala)₁₊ₙ-CO—CH(NHAc)-CH₂—S—S— (n=1 to 5).

It is also possible to copolycondense the above-described triblock copolymers having structures of the H-(AA)₁₊ₙ-PIB-(AA)₁₊ₙ-H type with other polymers or other triblock copolymers which have, for example, carbonyl halide end groups or carbonyl halide-terminated oligoamide end blocks and are based on monomers other than isobutene or on telechelic middle blocks other than PIB to obtain inventive multiblock copolymers. Telechelic middle blocks other than PIB may, for example, be based on polyisoprene (“PI”), polystyrene (“PS”), polytetrahydrofuran, polyethylene oxide (“PEO”) or poly(L-lactic acid) [“PLLA”]. A typical repeat unit in such polymers obtained by copolycondensation is

-(AA)₁₊ₙ-(AA)ₘ-POL-(AA)ₘ-(AA)₁₊ₙ-PIB-

in which POL denotes a polymer not based on isobutene or a telechelic polymer not based on polyisobutene, m is from 0 to 3 and AA, PIB and n are each as defined above.

Similarly complex materials with advantageous performance properties can, apart from by introduction of the inventive triblock copolymers into the multiblock copolymers described, also be obtained by simple physical mixing of the inventive triblock copolymers with polymers or triblock copolymers of the general formula R-(AA)ₘ-POL-(AA)ₘ-R in which R, AA, POL and m are each as defined above.

The present invention also provides a process for preparing the inventive block copolymers, which comprises providing the blocks (A) with suitable reactive mono- or polyfunctional, for example bifunctional, groups and coupling the blocks (A) onto the oligoamides of the blocks (B) via these functional groups or coupling the blocks (A) onto the oligoamides of the blocks (B) by means of suitable linking reagents. This process is suitable especially for the preparation of block copolymers with structural elements (S) which are each at the distal end of the oligoamide unit or oligoamide chain or link a block (B) to a block (A) or two blocks (B) to one another. The reactive functional groups are preferably selected from amines, alcohols, aldehydes, isocyanates, thiols, halides, ethylenic or allylic double bonds, dicarbonyl halides, dicarboxylic anhydrides and bifunctional structural elements (S), for example bifunctional chromophores or fluorophores. The coupling can be effected via the terminal amino function or preferably - since the terminal amino group is usually capped with a protecting group - via the terminal carboxyl function of the oligoamides by customary synthesis techniques.

The present invention further also provides a process for preparing the inventive block copolymers with central structural elements (S′), which comprises reacting suitable precursors of the blocks (B) which have terminal amino or carboxyl functions with corresponding blocks (A) which have opposite terminal carboxyl or amino functions. Instead of free carboxyl functions, it is also possible to use corresponding reactive carboxylic acid derivatives such as carbonyl halides, carboxylic anhydrides or carbonyl isocyanates. For example, α,ω-biscarboxylic acids of the formula HOOC-alkylene-S′-alkylene-COOH where “alkylene” denotes spacers in the form of C1- to C12-alkylene moieties, especially C₁- to C₆-alkylene moieties such as methylene, 1,2-ethylene, 1,3-propylene, 1,4-butylene, 1,6-hexylene or 1,4-cyclohexylene, with amino-terminated polyisobutene blocks to give triblock copolymers of the PIB-NH—CO-alkylene-S′-alkylene-CO—NH-PIB structure. Typical structural elements (S′) here are, for example, oligo(2,5-thienylenes) (“oligothiophenes”) of the formula —(C₄H₂S)ᵣ— where q=1 to 6 repeat units, oligo-1,4-phenylenes (“oligophenylenes”) of the formula —(C₆H₄)ᵣ— where r=1 to 6 repeat units or “rylene derivatives” such as naphthalenedicarboxylic anhydride, naphthalenetetracarboxylic dianhydride, perylene-3,4-dicarboxylic 3,4-anhydride, perylene-3,4,9,10-tetracarboxylic 3,4,9,10-dianhydride, terylenedicarboxylic anhydride, terylenetetracarboxylic dianhydride, quaterylenedicarboxylic anhydride, quaterylenetetracarboxylic dianhydride, corresponding higher rylenedicarboxylic anhydrides and corresponding higher rylenetetracarboxylic dianhydrides, coronenedicarboxylic anhydride, coronenetetracarboxylic dianhydride, hexaperihexabenzocoronenedicarboxylic anhydride, hexaperihexabenzocoronenetetracarboxylic dianhydride, and fullerene derivatives such as fulleropyrrolidine.

The inventive block copolymers of the present invention are outstandingly suitable for producing fibers, microfibers and films. Such fibers, microfibers and films have similar properties and three-dimensional structures to those possessed by fiber or network materials which occur in nature, such as silk, collagen or wood. When the inventive block copolymers further comprise chromophores, fluorophores and organic semiconductors as additional structural elements (S), color effects, optoelectronic effects and/or electrical effects are also brought about in such materials, which makes them suitable for specific applications in industry.

The examples which follow are intended to illustrate the present invention without restricting it.

### EXAMPLE 1

### Preparation of the Triblock copolymer Ac-(L-Ala)2-PIB-(L-Ala)2-Ac

N-Acetyl-L-alanyl-L-alanine (700 mg, 3.46 mmol) and a bifunctional polyisobutene telechelic which was obtained from 1,3-bis(1-bromo-1-methylethyl)benzene as an initiator and isobutene and had also been provided at both distal ends with amino functions (3.93 g, 1.73 mmol, Mₙ=2270) were dissolved in 300 ml of anhydrous tetrahydrofuran. To this were added 0.89 ml (5.19 mmol) of N,N-diisopropylethylamine and 1.98 g (3.81 mmol) of benzotriazole-1-yloxytrispyrrolidinophosphonium hexafluorophosphate. After stirring at room temperature for 16 hours, the reaction mixture was diluted with excess aqueous hydrochloric acid, the organic solvent was distilled off and the product precipitated after cooling to room temperature was filtered off and dissolved again at 60° C. in tetrahydrofuran. The purifying operation outlined was repeated twice by reprecipitation with excess aqueous hydrochloric acid. Finally, the product was purified further by dissolution in dichloromethane and precipitation by concentration of the solution. The product was obtained in quantitative yield in the form of a white solid which was still somewhat moist.

### EXAMPLE 2

### Preparation of the Triblock Copolymer Fmoc-(L-Ala)₃-PIB-(L-Ala)₃-Fmoc

N-(9-Fluorenylmethoxycarbonyl)-L-alanyl-L-alanyl-L-alanine (4.36 g, 9.61 mmol) and a bifunctional polyisobutene telechelic which had been obtained from 1,3-bis(1-bromo-1-methylethyl)benzene as an initiator and isobutene and had also been provided at both distal ends with amino functions (10.9 g, 4.81 mmol, Mₙ=2270) were dissolved in 400 ml of anhydrous tetrahydrofuran. To this were added 2.47 ml (14.42 mmol) of N,N-diisopropylethylamine and 5.50 g (10.58 mmol) of benzotriazole-1-yloxytris-pyrrolidinophosphonium hexafluorophosphate. After stirring at room temperature for 16 hours, the reaction mixture was diluted with excess aqueous hydrochloric acid, the organic solvent was distilled off and the product precipitated after cooling to room temperature was filtered off and redissolved at 60° C. in tetrahydrofuran. The purifying operation outlined was repeated twice by reprecipitating with excess aqueous hydrochloric acid. Finally, the product was purified further by dissolution in dichloromethane and precipitation by concentration of the solution. This gave 14.18 g (94% yield) of a white solid.

¹H NMR (200 MHz, CDCl₃ and TFA): δ=0.81 (s, 12H, 2 PhC(CH₃)₂), 0.96-1.20 (m, 186H, 2 CHC H₃, 30 CH(CH₃)₂), 1.29-1.42 (m, 60H, 30 CH₂), 1.85 (s, 4H, 2 CH₂C(CH₃)₂Ph), 2.80-3.50 (m, 4H, 2 CH₂NH), 3.90-4.80 (m, 12H, 6 CH₃CH(O)NH, 2 fluorenyl CH, 2 FmocCO₂CH₂), 7.15-7.79 (m, 20H, aromatic H) ppm

### EXAMPLE 3

### Preparation of the Triblock Copolymer H-(L-Ala)₃-PIB-(L-Ala)₃-H

The triblock copolymer Fmoc-(L-Ala)₃-PIB-(L-Ala)₃-Fmoc from Example 2 (11.00 g, 3.50 mmol) was dissolved in 200 ml of piperidine. After stirring for 30 minutes, the solvent was distilled off under reduced pressure and the crude product was washed three times with cold n-heptane. Finally, the product was purified further by dissolution in dichloromethane and precipitation by concentration of the solution. This gave 7.76 g (82% yield) of a white solid.

¹H NMR (200 MHz, CDCl₃ and TFA): δ=0.81 (s, 12H, 2 PhC(CH₃)₂), 0.96-1.20 (m, 186H, 2 CHCH₃, 30 CH(CH₃)₂), 1.29-1.42 (m, 60H, 30 CH₂), 1.85 (s, 4H, 2 CH₂C(CH₃)₂Ph), 2.80-3.50 (m, 4H, 2 CH₂NH), 3.90-4.80 (m, 6H, 6 CH₃CH(O)NH), 7.15 (s, 3H, aromatic H), 7.38 (s, 1H, aromatic H) ppm

### EXAMPLE 4

### Preparation of the Triblock Copolymer Fmoc-(L-Ala)₅-PIB-(L-Ala)₅-Fmoc

N-(9-Fluorenylmethoxycarbonyl)-L-alanyl-L-alanine (283.8 mg, 0.74 mmol) and H-(L-Ala)₃-PIB-(L-Ala)₃-H from example 3 (1.00 g, 0.37 mmol) were dissolved in 200 ml of anhydrous tetrahydrofuran. To this were added 0.19 ml (1.11 mmol) of N,N-diisopropylethylamine and 290 mg (0.56 mmol) of benzotriazole-1-yloxytris-pyrrolidinophosphonium hexafluorophosphate. After stirring at room temperature for 16 hours, the reaction mixture was diluted with excess aqueous hydrochloric acid, the organic solvent was distilled off and the product precipitated after cooling to room temperature was filtered off and dissolved again at 60° C. in tetrahydrofuran. The purifying operation outlined was repeated twice by reprecipitation with excess aqueous hydrochloric acid. Finally, the product was purified further by dissolution in dichloromethane and precipitation by concentration of the solution. This gave 1.12 g (88% yield) of a white solid.

¹H NMR (200 MHz, CDCl₃ and TFA): δ=0.81 (s, 12H, 2 PhC(CH₃)₂), 0.96-1.20 (m, 186H, 2 CHCH₃, 30 CH(CH₃)₂), 1.29-1.42 (m, 60H, 30 CH₂), 1.85 (s, 4H, 2 CH₂C(CH₃)₂Ph), 2.80-3.50 (m, 4H, 2 CH₂NH), 3.90-4.80 (m, 16H, 10 CH₃CH(O)NH, 2 fluorenyl CH, 2 FmocCO₂CH₂), 7.15-7.79 (m, 20H, aromatic H) ppm

### EXAMPLE 5

### Preparation of the Triblock copolymer Fmoc-(L-Gly)2-PIB-(L-Gly)2-Fmoc

N-(9-Fluorenylmethoxycarbonyl)-L-glycyl-L-glycine (200 mg, 0.56 mmol) and a bifunctional polyisobutene telechelic which was obtained from 1,3-bis(1-bromo-1-methylethyl)benzene as an initiator and isobutene and had also been provided with amino functions at both distal ends (0.64 g, 0.28 mmol, Mₙ=2270) were dissolved together with 0.29 ml (1.69 mmol) of N,N-diisopropylethylamine in 50 ml of anhydrous tetrahydrofuran. To this were added 352.5 mg (0.67 mmol) of benzotriazole-1-yloxytris-pyrrolidinophosphonium hexafluorophosphate. After stirring at room temperature for 16 hours, the reaction mixture was admixed with 200 ml of 1 molar aqueous hydrochloric acid and stirred for 30 minutes. The organic solvent was then distilled off under reduced pressure, which precipitated the product as a viscous mass in the aqueous phase. The product was dissolved again in tetrahydrofuran. The purifying operation outlined was repeated twice by reprecipitation with 1 molar aqueous hydrochloric acid. The purified product was dissolved in dichloromethane and dried over magnesium sulfate. Concentration under reduced pressure gives 0.67 g of the product (89% yield) in the form of a viscous yellow oil.

1H NMR (400 MHz, CDCl₃): δ=0.8 (s, 12H, 2 PhC(CH₃)₂), 0.9-1.2 (m, 186H, 2 CHCH₃, 30 CH(CH₃)₂), 1.2-1.5 (m, 60H, 30 CH₂), 1.84 (s, 4H, 2 CH₂C(CH₃)₂Ph), 2.99, 3.16 (m, 4H, 2 CH₂NHR), 3.87 (s, 4H, COCH₂NHCO), 3.92 (s, 4H, COCH₂NHCO), 4.22 (t, J=6.4 Hz, 2H, fluorenyl CH), 4.46 (d, J=6.4 Hz, 4H, OCH₂), 7.12 (s, 3H, aromatic H) 7.31 (t, J=7.2 Hz, 2H, Ar—H), 7.4 (t, 2H, J=7.2 Hz, Ar—H), 7.58 (d, J=7.2 Hz, 4H, Ar—H), 7.76 (d, J=7.2 Hz, 4H, Ar—H), ppm

### EXAMPLE 6

### Preparation of the Diblock Copolymer PIB-(L-Ala)-(L-Gly)-Fmoc

Polyisobuteneamine of the structure H₃C—C(CH₃)₂—[CH₂—C(CH₃)₂]₁₆—CH₂—CH(CH₃)—(CH₂)₂—NH₂ (1.00 g, 2.71 mmol, Mn=1040), N-(9-fluorenylmethoxycarbonyl)-L-glycyl-L-alanine (283.8 mg, 0.74 mmol) and N,N-diisopropylethylamine (1.39 ml, 8.14 mmol) were dissolved in 200 ml of anhydrous tetrahydrofuran. To this were added 1.70 g (3.26 mmol) of benzotriazole-1-yloxytrispyrrolidinophosphonium hexafluorophosphate. After stirring at room temperature for 16 hours, the reaction mixture was admixed with 400 ml of 1 molar aqueous hydrochloric acid and stirred for 30 minutes. The organic solvent was then distilled off under reduced pressure, which precipitated the product as a viscous mass in the aqueous phase. After removal of the aqueous phase, the product was dissolved again in dichloromethane. The aqueous phase removed was extracted with further dichloromethane. The combined dichloromethane phases were dried over magnesium sulfate, washed three times with 1 molar aqueous hydrochloric acid and concentrated under reduced pressure. The product was obtained in quantitative yield in the form of a viscous yellow oil.

1H NMR (400 MHz, CDCl₃): δ=0.9-1.5 (m, 145H, aliphatic H, 3H CHC H₃), 3.15-3.35 (m, 2H, CH₂NHR), 3.87 (m, 2H, COCH₂NHCO), 4.22 (t, J=6.8 Hz, 1H, fluorenyl CH), 4.43 (m, 2H, OCH₂, 1H, CHCH₃), 5.5 (s, 1H, carbamate NH), 6.08 (s, 1H, NH), 6, 6.64 (d, 1H, NH), 7.31 (t, J=7.2 Hz, 2H, Ar—H), 7.4 (t, 2H, J=7.2 Hz, Ar—H), 7.58 (d, J=7.2 Hz, 2H, Ar—H), 7.76 (d, J=7.2 Hz, 2H, Ar—H), ppm

### EXAMPLE 7

### Preparation of a Triblock Copolymer with a bis(amidopropyl)-tetra(2,5-thienylene) Middle Block

Polyisobuteneamine of the H₃C—C(CH₃)₂—[CH₂—C(CH₃)₂]₈—CH₂—CH(CH₃)—(CH₂)₂—NH₂ structure (0.09 g, 0.15 mmol, Mₙ=590) and 5,5′″-bis(butanoic acid)-2,2′:5′,2″:5″,2′″-tetrathiophene (36.9 mg, 0.07 mmol) were dissolved in 70 ml of anhydrous tetrahydrofuran. Then N,N-diisopropylethylamine (76.0 mg, 0.60 mmol) and benzotriazole-1-yloxytrispyrrolidinophosphonium hexafluorophosphate (97.0 mg, 0.18 mmol) were added. After a reaction time of 2 hours, the solution was concentrated under reduced pressure. The residue was poured into ice-cold 1 molar aqueous hydrochloric acid. Then the precipitates formed were redissolved in tetrahydrofuran. The precipitation operation was repeated three times. This gave 0.12 g of the purified product (corresponding to a yield of 90%) in the form of a yellow oil. The product has the following structural formula:

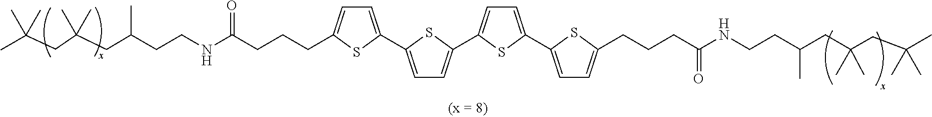

¹H NMR (200 MHz, CDCl₃): δ=0.9-1.5 (m, 200H, aliphatic H), 1.8 (m 4H, 2 CH₂), 2.1 (m, 4H, 2 C(O)CH₂), 2.8 (4H, 2 CH₂), 3.2 (m, 4H, CH₂NHR), 5.3 (s, 1H, NH), 6.7 (d, 2H, aromatic H), 7.0 (m, 6H, aromatic H), ppm

1. A block copolymer with the properties of thermoplastic elastomers, comprising at least one block (A) based on isobutene monomer units as a soft segment and at least one block (B) based on oligoamides formed from at least two base units each having an amino group and a carbonyl group in the α, β, γ or δ positions relative to one another or bonded directly to one another as a hard segment.

2. The block copolymer according to claim 1, in which the at least one block (A) is a monofunctional polyisobutene block.

3. The block copolymer according to claim 1, in which the at least one block (A) is a polyisobutene telechelic.

4. The block copolymer according to claim 1, in which the at least one block (A) is a polyisobutene block having a number-average molecular weight of 270 to 5000.

5. The block copolymer according to claim1, in which the at least one block (B) comprises oligoamides of aliphatic α-, β-, γ- or δ-amino acids or of aromatic β-, γ- or δ-amino acids.

6. The block copolymer according to claim 1, in which the at least one block (B) comprises monodisperse oligopeptides of naturally occurring α-amino acids as oligoamides.

7. The block copolymer according to claim 5, in which the at least one block (B) comprises additional structural elements (S) selected from protecting groups, chromophores, fluorophores, organic semiconductors and precursors for such structural elements, each of which are at the distal end of the oligoamide unit or oligoamide chain or join a block (B) to a block (A) or two blocks (B) to one another.

8. The block copolymer according to claim 5, in which the oligoamides consist of 2 to 10 amino acid units.

9. The block copolymer according to claim 1, in which the at least one block (B) comprises at least one additional structural element (S′) selected from chromophores, fluorophores, organic semiconductors and precursors for such structural elements, which is arranged between two amide moieties.

10. A diblock copolymer having an (A)-(B)-R structure in which (A) is a monofunctional polyisobutene block and (B) is based on oligoamides formed from at least two base units each having an amino group and a carbonyl group in the α, β, γ or δ positions relative to one another or bonded directly to one another as a hard segment, and R is hydrogen or structural elements (S) according to claim 7.

11. A triblock copolymer having an R-(B)-(A)-(B)-R structure in which (A) is a polyisobutene telechelic and (B) denotes blocks based on oligoamides formed from at least two base units each having an amino group and a carbonyl group in the α, β, γ or δ positions relative to one another or bonded directly to one another as a hard segment, and R is hydrogen or structural elements (S) according to claim 7.

12. A multiblock copolymer comprising, as macrostructural elements, triblock copolymer structural elements having a formula -(B)-(A)-(B)- in which (A) is a polyisobutene telechelic and (B) denotes blocks based on oligoamides formed from at least two base units each having an amino group and a carbonyl group in the α, β, γ or δ positions relative to one another or bonded directly to one another as the hard segment.

13. A process for preparing block copolymers according to claim 1, which comprises providing the blocks (A) with suitable reactive mono- or polyfunctional groups and coupling the blocks (A) onto the oligoamides of the blocks (B) via these functional groups or coupling the blocks (A) onto the oligoamides of the blocks (B) by means of suitable linking reagents.

14. The process for preparing block copolymers according to claim 13, wherein the reactive functional groups are selected from amines, alcohols, aldehydes, isocyanates, thiols, halides, ethylenic or allylic double bonds, dicarbonyl halides, dicarboxylic anhydrides and wherein at least one block (B) comprises additional structural elements (S) selected from protecting groups, chromophores, fluorophores, organic semiconductors and precursors for such structural elements, each of which are at the distal end of the oligoamide unit or oligoamide chain or join a block (B) to a block (A) or two blocks (B) to one another.

15. A process for preparing block copolymers according to claim 9, which comprises reacting suitable precursors of the blocks (B) which have terminal amino or carboxyl functions with corresponding blocks (A) which have opposite terminal carboxyl or amino functions.

16. The use of block copolymers according to claim 1 for producing fibers, microfibers and films.

17. A process for preparing block copolymers according to claim 10, which comprises providing the blocks (A) with suitable reactive mono- or polyfunctional groups and coupling the blocks (A) onto the oligoamides of the blocks (B) via these functional groups or coupling the blocks (A) onto the oligoamides of the blocks (B) by means of suitable linking reagents.

18. A process for preparing block copolymers according to claim 11, which comprises providing the blocks (A) with suitable reactive mono- or polyfunctional groups and coupling the blocks (A) onto the oligoamides of the blocks (B) via these functional groups or coupling the blocks (A) onto the oligoamides of the blocks (B) by means of suitable linking reagents.

19. A process for preparing block copolymers according to claim 12, which comprises providing the blocks (A) with suitable reactive mono- or polyfunctional groups and coupling the blocks (A) onto the oligoamides of the blocks (B) via these functional groups or coupling the blocks (A) onto the oligoamides of the blocks (B) by means of suitable linking reagents.

20. The block copolymer according to claim 6, in which the at least one block (B) comprises additional structural elements (S) selected from protecting groups, chromophores, fluorophores, organic semiconductors and precursors for such structural elements, each of which are at the distal end of the oligoamide unit or oligoamide chain or join a block (B) to a block (A) or two blocks (B) to one another.
